(19) United States
(12) Patent Application Publication
(10) Pub. No.: US 2024/0183556 A1
(43) Pub. Date: Jun. 6, 2024

(54) EQUIPMENT CONTROL DEVICE, EQUIPMENT CONTROL METHOD, AND COMPUTER READABLE MEDIUM

(71) Applicant: MITSUBISHI ELECTRIC CORPORATION, Tokyo (JP)

(72) Inventors: Yoshihiro OHTA, Tokyo (JP); Masanori HASHIMOTO, Tokyo (JP); Jin KAWASAKI, Tokyo (JP); Shinichiro OTANI, Tokyo (JP); Risa MURAKAMI, Tokyo (JP); Yosuke KANEKO, Tokyo (JP); Hiroyuki SATO, Tokyo (JP); Kohei FUKUHARA, Tokyo (JP); Ryo KUMAGAI, Tokyo (JP)

(73) Assignee: MITSUBISHI ELECTRIC CORPORATION, Tokyo (JP)

(21) Appl. No.: 18/439,924

(22) Filed: Feb. 13, 2024

Related U.S. Application Data
(63) Continuation of application No. PCT/JP2021/033246, filed on Sep. 10, 2021.

(51) Int. Cl. F24F 11/47; F24F 11/56; F24F 120/20

(52) U.S. Cl. CPC F24F 11/47; F24F 11/56; F24F 2120/20

(57) ABSTRACT

A result acquisition unit (130) obtains, for each candidate setting, a simulation result of a case where a candidate setting is applied to the one or more units of equipment. A satisfaction level calculation unit (140) calculates, for each candidate setting, a satisfaction level on a basis of the simulation result. A constraint level calculation unit (150) calculates, for each candidate setting, a constraint level on a basis of the simulation result. A candidate optimization unit (160) judges superiority/inferiority of a plurality of candidate settings on a basis of the satisfaction level of each candidate setting and the constraint level of each candidate setting, and optimizes the plurality of candidate settings on a basis of a judgment result, thereby generating a plurality of new candidate settings. A selection unit selects an applicable setting from the plurality of new candidate settings. A control unit applies the applicable setting to equipment.

### CROSS REFERENCE TO RELATED APPLICATIONS

This application is a Bypass Continuation of PCT International Application No. PCT/JP2021/033246, filed on Sep. 10, 2021, all of which is hereby expressly incorporated by reference into the present application.

### TECHNICAL FIELD

The present disclosure relates to control of building equipment.

### BACKGROUND ART

In offices, factories, and so on, equipment is controlled such that energy consumption does not exceed a specified value.

On the other hand, if the energy consumption is reduced more than necessary, there is a risk that the comfort of the residents will be impaired. Therefore, it is important to reduce energy consumption while maintaining the comfort of the residents.

For example, Patent Literature 1 discloses a technology for assisting planning of power-saving measures. Specifically, data of an area of a building is collected. Power consumed by lighting equipment and air conditioning equipment is calculated on a basis of the collected data in accordance with the burden (average illuminance, discomfort index, and the like) perceived by people. A power saving effect based on the calculated power consumption is provisionally calculated.

### CITATION LIST

### Patent Literature

Patent Literature 1: Japanese Patent No. 6389934 B2

### SUMMARY OF INVENTION

### Technical Problem

The technology described in Patent Literature 1 cannot cope with energy consumption reduction by controlling equipment other than lighting equipment and air conditioning equipment.

The technology described in Patent Literature 1 can cope with a power saving goal of a building manager. Further, the technology described in Patent Literature 1 can cope with a thermal environment and light environment of users of the building.

However, a building has many stakeholders such as owners and tenants in addition to the manager and users. Each stakeholder has a different demand.

The technology described in Patent Literature 1 cannot meet the user's demand regarding an air quality environment, the user's demand regarding a sound environment, the owner's or tenant's demand regarding productivity, the owner's or tenant's demand regarding a CO₂ emission amount, and so on.

The technology described in Patent Literature 1 can satisfy a temperature-and-humidity reference range defined by the Building Management Law.

However, there are constraints that must be always satisfied when controlling building equipment.

The technology described in Patent Literature 1 cannot perform control that always satisfies the reference range of CO₂ concentration and the like.

The present disclosure has as its objective to be able to assist an operation of a building while satisfying constraints necessary for the operation of the building and considering stakeholder demands.

### Solution to Problem

An equipment control device of the present disclosure includes:
a result acquisition unit to obtain, for each candidate setting, a simulation result on a basis of a plurality of candidate settings which are a plurality of candidates for a setting to control one or more units of equipment installed in a building, the simulation result corresponding to a result of an operation of the building of a case where the candidate setting is applied to the one or more units of equipment;
a satisfaction level calculation unit to calculate, for each candidate setting, a satisfaction level of a stakeholder of the building on a basis of the simulation result;
a constraint level calculation unit to calculate, for each candidate setting, a constraint level on a basis of the simulation result, the constraint level expressing a degree of how much an operation constraint of the building is satisfied;
a candidate optimization unit to judge superiority/inferiority of the plurality of candidate settings on a basis of the satisfaction level of each candidate setting and the constraint level of each candidate setting, and to optimize the plurality of candidate settings on a basis of a judgment result, thereby generating a plurality of new candidate settings;
a selection unit to select a candidate setting to be applied to the one or more units of equipment as an applicable setting from among the plurality of new candidate settings; and
a control unit to apply the applicable setting to the one or more units of equipment.

### Advantageous Effects of Invention

According to the present disclosure, a candidate setting that has been optimized on a basis of both a satisfaction level and a constraint level is applied to equipment of a building. Therefore, it is possible to assist an operation of the building while satisfying constraints necessary for the operation of the building and while considering stakeholders' demands.

### BRIEF DESCRIPTION OF DRAWINGS

FIG. 1 is a configuration diagram of a building management system 200 in Embodiment 1.

FIG. 2 is a configuration diagram of an equipment control device 100 in Embodiment 1.

FIG. 3 is a configuration diagram of a calculation unit 111 in Embodiment 1.

FIG. 4 is a functional relationship diagram of the equipment control device 100 in Embodiment 1.

FIG. 5 is a flowchart of an equipment control method in Embodiment 1.

FIG. 6 is a diagram illustrating a constraint win-loss table in Embodiment 1.

FIG. 7 is a flowchart of an equipment control method in Example (1-3).

FIG. 8 is a configuration diagram of a calculation unit 111 in Embodiment 2.

FIG. 9 is a functional relationship diagram of an equipment control device 100 in Embodiment 2.

FIG. 10 is a flowchart of an equipment control method in Embodiment 2.

FIG. 11 is a configuration diagram of a calculation unit 111 in Embodiment 3.

FIG. 12 is a functional relationship diagram of an equipment control device 100 in Embodiment 3.

FIG. 13 is a flowchart of an equipment control method in Embodiment 3.

FIG. 14 is a functional relationship diagram of an equipment control device 100 in Example (3-2).

FIG. 15 is a functional relationship diagram of an equipment control device 100 in Example (3-3).

FIG. 16 is a functional relationship diagram of an equipment control device 100 in Example (3-4).

FIG. 17 is a configuration diagram of an equipment control device 100 in Embodiment 4.

FIG. 18 is a functional relationship diagram of the equipment control device 100 in Embodiment 4.

FIG. 19 is a flowchart of an equipment control method in Embodiment 4.

FIG. 20 is a functional relationship diagram of an equipment control device 100 in Example (4-2).

FIG. 21 is a configuration diagram of an equipment control device 100 in Embodiment 5.

FIG. 22 is a functional relationship diagram of the equipment control device 100 in Embodiment 5.

FIG. 23 is a flowchart of an equipment control method in Embodiment 5.

FIG. 24 is a configuration diagram of a calculation unit 111 in Embodiment 6.

FIG. 25 is a functional relationship diagram of an equipment control device 100 in Embodiment 6.

FIG. 26 is a flowchart of an equipment control method in Embodiment 6.

FIG. 27 is a functional relationship diagram of an equipment control device 100 in Example (6-1).

FIG. 28 is a hardware configuration diagram of the equipment control device 100 in the embodiments.

### DESCRIPTION OF EMBODIMENTS

In embodiments and drawings, the same elements or equivalent elements are denoted by the same reference sign. An explanation of an element denoted by the same reference sign as that of a described element will appropriately be omitted or simplified. Arrows in the drawings mainly indicate data flows or process flows.

### Embodiment 1

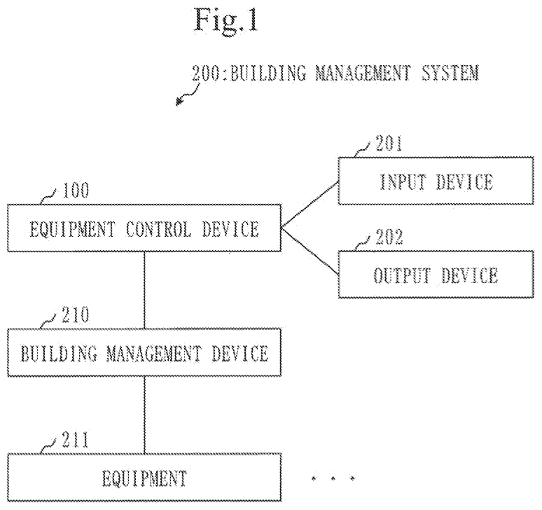

A building management system 200 will be described with referring to FIGS. 1 to 7.

### Description of Configurations

A configuration of the building management system 200 will be described with referring to FIG. 1.

The building management system 200 is provided with an equipment control device 100 and a building management device 210.

The equipment control device 100 and the building management device 210 are connected to each other via a network, or directly without a network intervened.

The building management system 200 is connected to an input device 201 and an output device 202.

The input device 201 is an apparatus operated by a user. For example, the input device 201 is a mouse, a keyboard, a touch panel, or the like.

The output device 202 is an apparatus that outputs data. For example, the output device 202 is a display or a printer.

The building management device 210 is a device similar to a BAS and is connected to one or more units of equipment 211 installed in the building. The building management device 210 performs setting of each equipment 211 and monitors a state of each equipment 211.

For example, the equipment 211 is air conditioning equipment, illumination equipment, ventilation equipment, hot water supply equipment, or the like.

Note that BAS stands for Building Automation System.

Note that the building management system 200 may be integrated in the equipment control device 100.

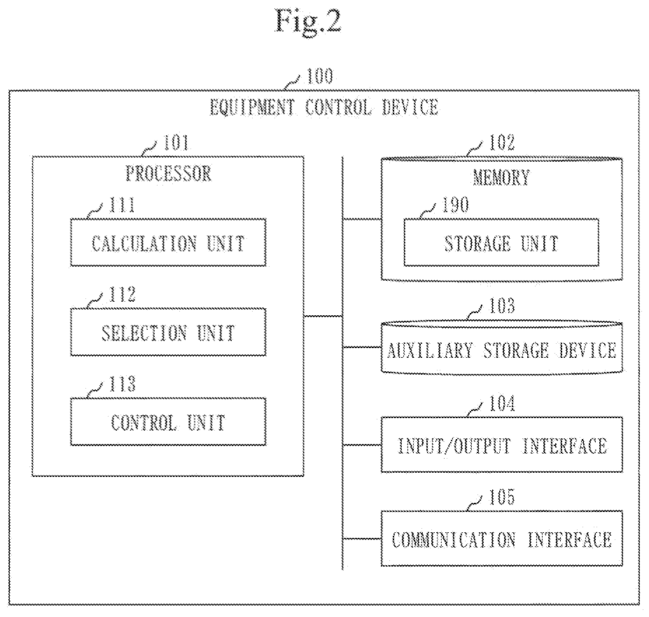

A configuration of the equipment control device 100 will be described with referring to FIG. 2.

The equipment control device 100 is a computer provided with hardware devices such as a processor 101, a memory 102, an auxiliary storage device 103, an input/output interface 104, and an communication interface 105. These hardware devices are connected to each other via a signal line.

The processor 101 is an IC that performs computation processing, and controls the other hardware devices. For example, the processor 101 is a CPU.

Note that IC stands for Integrated Circuit.

Note that CPU stands for Central Processing Unit.

The memory 102 is a volatile or nonvolatile storage device. The memory 102 is also called main storage device or main memory. For example, the memory 102 is a RAM. Data stored in the memory 102 is saved in the auxiliary storage device 103 as necessary.

Note that RAM stands for Random-Access Memory.

The auxiliary storage device 103 is a nonvolatile storage device. For example, the auxiliary storage device 103 is one or a combination of a ROM, an HDD, and a flash memory. Data stored in the auxiliary storage device 103 is loaded in the memory 102 as necessary.

Note that ROM stands for Read-Only Memory.

Note that HDD stands for Hard Disk Device.

The input/output interface 104 is a port to which the input device 201 and the output device 202 are connected. For example, the input/output interface 104 is a USB or HDMI (registered trademark) terminal. Inputting and outputting of the equipment control device 100 is performed with using the input/output interface 104.

Note that USB stands for Universal Serial Bus.

Note that HDMI stands for High-Definition Multimedia Interface.

The communication interface 105 is a receiver/transmitter. For example, the communication interface 105 is a communication chip or an NIC. The equipment control device 100 performs communication with using the communication interface 105.

Note that NIC stands for Network Interface Card.

The equipment control device 100 is provided with elements such as a calculation unit 111, a selection unit 112, and a control unit 113. These elements are implemented by software.

An equipment control program to cause the computer to function as the calculation unit 111, the selection unit 112, and the control unit 113 is stored in the auxiliary storage device 103. The equipment control program is loaded to the memory 102 and run by the processor 101.

An OS is further stored in the auxiliary storage device 103. At least part of the OS is loaded to the memory 102 and executed by the processor 101.

The processor 101 runs the equipment control program while executing the OS.

Note that OS stands for Operating System.

Input/output data of the equipment control program is stored in a storage unit 190.

The memory 102 functions as the storage unit 190. A storage device such as the auxiliary storage device 103, a register in the processor 101, and a cache memory in the processor 101 may function as the storage unit 190 in place of the memory 102 or together with the memory 102.

The equipment control device 100 may be provided with a plurality of processors that substitute for the processor 101.

The equipment control program can be computer readably recorded (stored) in a nonvolatile recording medium such as an optical disk and a flash memory.

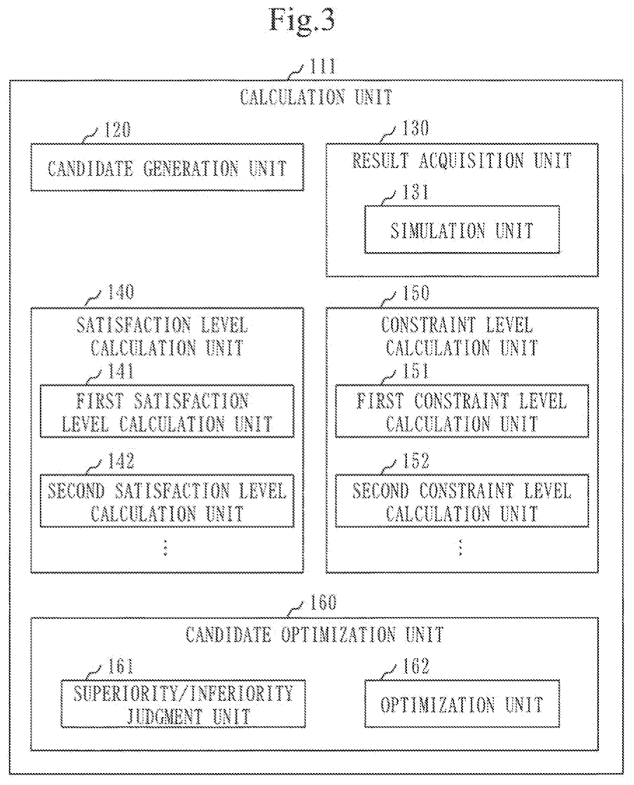

A configuration of the calculation unit 111 will be described with referring to FIG. 3.

The calculation unit 111 is provided with a candidate generation unit 120, a result acquisition unit 130, a satisfaction level calculation unit 140, a constraint level calculation unit 150, and a candidate optimization unit 160.

The result acquisition unit 130 is provided with a simulation unit 131.

The satisfaction level calculation unit 140 is provided with one or more satisfaction level calculation units. For example, the satisfaction level calculation unit 140 is provided with a first satisfaction level calculation unit 141 and a second satisfaction level calculation unit 142.

The constraint level calculation unit 150 is provided with one or more constraint level calculation units. For example, constraint level calculation unit 150 is provided with a first constraint level calculation unit 151 and a second constraint level calculation unit 152.

The candidate optimization unit 160 is provided with a superiority/inferiority judgment unit 161 and an optimization unit 162.

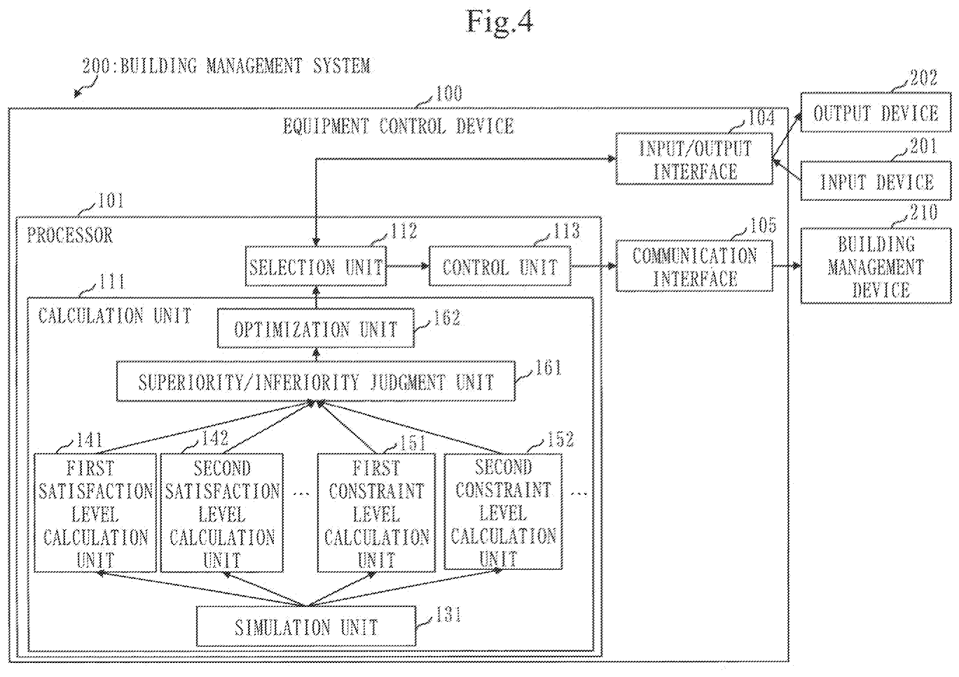

FIG. 4 illustrates relationships among major elements of the building management system 200.

Arrows in FIG. 4 mainly indicate data flows or process flows.

### Description of Operations

A procedure of operations of the equipment control device 100 corresponds to an equipment control method. The procedure of the operations of the equipment control device 100 also corresponds to a procedure of processes by the equipment control program.

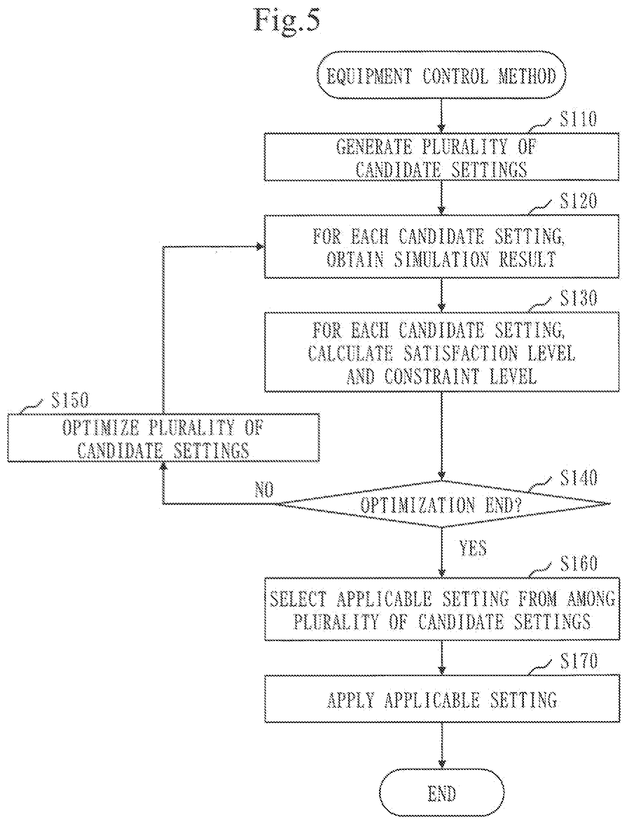

The equipment control method will be described with referring to FIG. 5.

In step S110, the candidate generation unit 120 generates a plurality of candidate settings.

A candidate setting is a candidate of setting data to control one or more units of equipment 211.

The setting data shows values to be assigned to control parameters of the equipment 211.

For example, the plurality of candidate settings are generated as follows.

Setting range data is stored in the storage unit 190 in advance. The setting range data shows, for each control parameter, a range of a value that can be set.

For each control parameter, the candidate generation unit 120 selects values (a plurality of values) as many as the candidate settings from the range shown in the setting range data. Then, for each control parameter, the candidate generation unit 120 includes the plurality of selected values in different candidate settings.

For example, the plurality of values are selected at a fixed interval. The plurality of values may be selected by sampling according to the design of experiments, by sampling utilizing random numbers, or the like.

In step S120, the result acquisition unit 130 obtains, for each candidate setting, a simulation result on a basis of the plurality of candidate settings.

The simulation result corresponds to a result of an operation of a building of a case where the candidate setting is applied to the one or more units of equipment 211.

Specifically, the simulation result indicates an energy consumption of each equipment 211, an indoor environment of each room, and so on.

The simulation result is obtained as follows.

The simulation unit 131 simulates the operation of the building of the case where the candidate setting is applied to one or more units of equipment 211.

To perform the simulation, existing software such as BEST, EnergyPlus, and modelica can be employed.

In step S130, the satisfaction level calculation unit 140 calculates, for each candidate setting, a satisfaction level of a stakeholder of the building on a basis of the simulation result.

The satisfaction level is a value expressing a degree of satisfaction the stakeholder of the building can obtain.

For example, the satisfaction level calculation unit 140 calculates, for each candidate setting, a plurality of satisfaction levels about a plurality of indices. In this case, the first satisfaction level calculation unit 141 calculates a satisfaction level (first satisfaction level) about a first satisfaction index, and the second satisfaction level calculation unit 142 calculates a satisfaction level (second satisfaction level) about a second satisfaction index.

For example, following indices can be raised as indices (satisfaction indices) concerning satisfaction levels.

An index concerning a thermal environment. A specific example is Predicted Mean Vote (PMV).

An index concerning a light environment. Specific examples are illuminance and brightness.

An index concerning an air quality environment. A specific example is a concentration of carbon dioxide (CO₂).

An index concerning a sound environment. Specific examples are sound fluctuation strength and roundness.

An index concerning a psychological environment of a building user. A specific example is a concentration level.

Various types of indices concerning a building owner or a building manager. Specific examples are energy consumption, peak power, electricity bill, gas bill, and a CO₂ emission amount.

Each satisfaction level may be a value about the whole building, or may be a per-room converted value or a per-person converted value.

Furthermore, the constraint level calculation unit 150 calculates, for each candidate setting, a constraint level on a basis of the simulation result.

The constraint level is a value expressing a degree of how much a constraint (operation constraint) requested of the operation of the building is satisfied.

For example, the constraint level calculation unit 150 calculates a plurality of constraint levels about a plurality of indices. In this case, the first constraint level calculation unit 151 calculates a constraint level (first constraint level) about a first constraint index, and the second constraint level calculation unit 152 calculates a constraint level (second constraint level) about a second constraint index.

For example, following indices can be raised as indices (constraint indices) concerning constraint levels.

A regulation value concerning energy. A specific example is a CO₂ reference emission amount.

Guidelines for management of environmental health of buildings provided by the Ministry of Health, Labour and Welfare. A specific example is a reference range of a temperature, relative humidity, content rate of carbon dioxide, amount of formaldehyde, and so on.

A reference value prescribed by JIS standards (JIS Z 9110: 2010). A specific example is a reference value of indoor average desk-surface illuminance, a uniformity ratio of illuminance, and so on.

Each satisfaction level may be a value of the whole building, or may be a per-room converted value or a per-person converted value.

In step S140, the candidate optimization unit 160 judges whether an optimization end condition is satisfied.

The optimization end condition is determined in advance as a condition for ending optimization of a plurality of candidate settings.

For example, the optimization end condition is prescribed about an item such as a number of execution times of optimization (step S150) and a goal value of the satisfaction level. Optimization end conditions may be prescribed about a plurality of items.

If the optimization end condition is not satisfied, the processing proceeds to step S150. If the optimization end condition is satisfied, the processing proceeds to step S160.

In step S150, the candidate optimization unit 160 optimizes the plurality of candidate settings on a basis of a satisfaction level of each candidate setting and a constraint level of each candidate setting. Hence, a plurality of new candidate settings are generated.

Optimization is performed as follows.

First, the superiority/inferiority judgment unit 161 judges superiority/inferiority of the plurality of candidate settings on a basis of the satisfaction level of each candidate setting and the constraint level of each candidate setting. Specifically, the superiority/inferiority judgment unit 161 ranks the plurality of candidate settings.

Then, the optimization unit 162 optimizes the plurality of candidate settings on a basis of a superiority/inferiority judgment result (ranks of the candidate settings).

Details of the superiority/inferiority judgment unit 161 will be described.

The superiority/inferiority judgment unit 161 performs ranking on a basis of each of the satisfaction level and the constraint level. Then, the superiority/inferiority judgment unit 161 ranks the plurality of candidate settings on a basis of a ranking result on a basis of the satisfaction level and a ranking result on a basis of the constraint level.

The ranking based on the constraint level is carried out with using a technique called “constraint win/loss rank”.

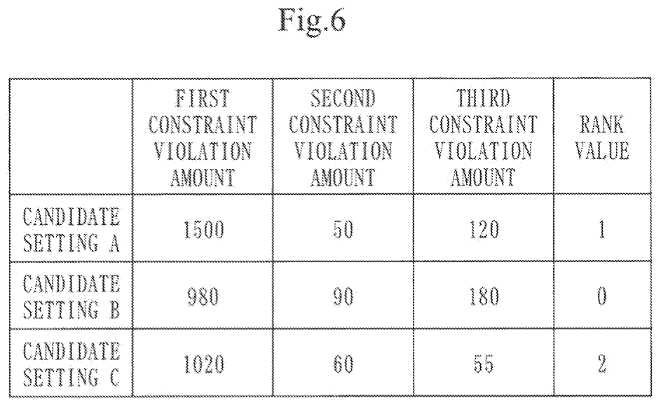

The “constraint win/loss rank” will be described with referring to FIG. 6.

According to the “constraint win/loss rank”, for example, win/loss of candidate settings is determined on a basis of a constraint violation amount. The constraint violation amount is an example of the constraint level and expresses how much an index value deviates from the reference. A first constraint violation amount is a constraint violation amount from a first constraint index, a second constraint violation amount is a constraint violation amount from a second constraint index, and a third constraint violation amount is a constraint violation amount from a third constraint index.

A candidate setting A and a candidate setting B will be compared. Regarding the first constraint index, a constraint violation amount of the candidate setting B is smaller than a constraint violation amount of the candidate setting A. Regarding the second constraint index and the third constraint index, constraint violation amounts of the candidate setting A are smaller than constraint violation amounts of the candidate setting B. Therefore, the candidate setting A is superior to the candidate setting B in two constraint indices, and the candidate setting B is superior to the candidate setting A in one constraint index. That is, a number of constraint indices by which the candidate setting A is superior is larger than a number of constraint indices by which the candidate setting B is superior. Hence, the candidate setting A is superior to the candidate setting B.

Likewise, when a candidate setting C is compared with the candidate setting A and the candidate setting B, the candidate setting C is superior to any of the candidate setting A and the candidate setting B.

A rank value expresses a number of wins over other candidate settings. A rank value of the candidate setting A is 1, a rank value of the candidate setting B is 0, and a rank value of the candidate setting C is 2.

The larger the rank value, the higher the rank. Accordingly, the rank of the candidate setting C is the highest.

According to the “constraint win/loss rank”, a candidate setting that is superior in a larger number of constraint indices has a higher rank.

With the “constraint win/loss rank”, ranking can be performed even if the unit of value and the range of value largely differ among the constraint indices. That is, ranking can be performed without paying attention to differences in types of constraint levels.

Note that ranking may be performed according to a method other than the “constraint win/loss rank”.

For example, first, ranking may be performed by comparison under each constraint index, and after that total ranking may be performed by synthesizing the ranks under the individual constraint indices.

Also, the constraint violation amount from each constraint index may be weighted, then a weighting sum of the constraint violation amounts may be calculated under each candidate setting, and after that ranking may be performed using the weighting sums of the individual candidate settings.

Ranking based on the satisfaction level is carried out with using a technique like the one employed in existing multi-objective optimization computation. A technique of ranking on a basis of a fitness level F employed by IBEA will be described below. The fitness level F is calculated by normalizing each satisfaction level. The fitness level F to a certain candidate setting x¹ is defined by expression (1).

$$[ Formula 1 ]$$

$$F ( {x}^{1} ) = {\sum }_{{x}^{2} ∈ P \backslash \{ {x}^{1} \}} - {e}^{- J ( \{ {x}^{2} \} , \{ {x}^{1} \} ) / ( c \cdot κ )} \qquad ( 1 )$$

Note that “x¹” is a candidate setting being a target whose fitness level F is to be calculated, and is expressed by a vector.

Note that “P” is a set of candidate settings.

Note that “x²” is a setting candidate other than the setting candidate x¹ in the set P of setting candidates.

Note that “I(A, B)” is a normalization result of a minimum value (Iε+(A, B)) of a value ε that is at least required to make the satisfaction level of the setting candidate A equal to the satisfaction level of the setting candidate B. Note that “I(A, B)” is defined by expression (2).

$$[ Formula 2 ]$$

$$I ( A , B ) = {min}_{ε} \{ {f}_{i}^{′} ( A ) - ε \leq {f}_{i}^{′} ( B ) : i ∈ 1 , … , m \} \qquad ( 2 )$$

Note that “m” is a variable expressing a figure of the satisfaction level (for example, m=2).

Note that “f″i(x)” is a normalization result of a function fi(x) which serves to obtain an ith satisfaction level about a candidate setting x. Note that “f″i(x)” is defined by expression (3).

[Formula 3]

ƒ′ᵢ(x)=(ƒᵢ(x)−min{ƒᵢ})/(max{ƒᵢ}−min{ƒᵢ}) (3)

Note that “c” and “κ” are normalization coefficients. A value of “κ” is a constant (for example, κ=0.05). Note that “c” is defined by expression (4).

$$[ Formula 4 ]$$

$$c = {max}_{{x}^{1} , {x}^{2} ∈ P} \vert I ( {x}^{2} , {x}^{1} ) \vert \qquad ( 4 )$$

A high fitness level F signifies that an improvement width, which is necessary to improve the satisfaction level, of a relevant setting candidate is largely inferior when compared to the other setting candidates.

Therefore, by calculating the fitness level F of each candidate setting, the setting candidates can be ranked in descending order of the satisfaction level.

Further, since the satisfaction level is normalized by expression (3), ranking can be performed even if the unit of value and the range of value largely differ among the satisfaction indices. That is, ranking can be performed by calculating the fitness level F without paying attention to differences in types of satisfaction levels.

Ranking based on the satisfaction level may be performed by a technique other than the technique based on the fitness level of IBEA.

For example, ranking may be performed by a method based on “Pareto ranking” or “crowding distance”. “Pareto ranking” and “crowding distance” are often employed in a multi-objective genetic algorithm (MOGA).

Ranking may be performed by a technique employed in NSGA-III or MOEA/D. NSGA-III and MOEA/D are optimization algorithms suitable for many objective functions.

Details of the optimization unit 162 will be described.

First, the optimization unit 162 generates a candidate setting anew with using a technique like the one employed in the above-mentioned existing multi-objective optimization computation. A number of setting candidates to be generated anew may be one, or may be plural.

For example, the optimization unit 162 uses a technique like the one often employed in the multi-objective genetic algorithm (MOGA). That is, the higher the rank, the higher the possibility that the optimization unit 162 extracts two candidate settings, synthesizes respective setting values of the two candidate settings by SBX, and mutates the synthetic value by PM. A synthetic value after the mutation is the setting value of a new candidate setting. Note that SBX stands for Simulated Binary Crossover, and PM stands for Polynomial-based Mutation.

Then, the optimization unit 162 mixes the candidate setting generated anew with the original candidate settings to prepare a plurality of new candidate settings.

The optimization unit 162 may handle the plurality of new candidate settings with using a technique like the one employed in the above-mentioned existing multi-objective optimization computation.

For example, if a number of new candidate settings which are plural is larger than a threshold value, the optimization unit 162 deletes one or more candidate settings from the plurality of new candidate settings in ascending order such that the number of new candidate settings which are plural is equal to or smaller than the threshold value. After step S150, the processing proceeds to step S120.

In step S160, the selection unit 112 selects an applicable setting from among the plurality of new candidate settings.

The applicable setting is a candidate setting to be applied to one or more units of equipment 211.

For example, the applicable setting is selected as follows.

First, the selection unit 112 displays the plurality of new candidate settings to a display (output device 202).

Next, a user (for example, the building manager) refers to the plurality of new candidate settings, selects a desirable candidate setting from among the plurality of new candidate settings, and designates the desirable candidate setting with using the input device 201.

Then, the selection unit 112 selects the designated candidate setting from among the plurality of new candidate settings. The candidate setting to be selected is the applicable setting.

In step S170, the control unit 113 applies the applicable setting to one or more units of equipment 211.

Specifically, the control unit 113 transmits the applicable setting to the building management device 210. Then, the building management device 210 applies the applicable setting to each equipment 211.

### Effect of Embodiment 1

The equipment control device 100 generates a plurality of candidate settings. At this time, the equipment control device 100 repeats deleting a candidate setting having a low constraint level and a low satisfaction level and generating a new candidate setting with using a candidate setting having a high rank. Thus, a plurality of candidate settings having a high constraint level and a high satisfaction level can be obtained.

Then, the equipment control device 100 presents the plurality of candidate settings to the user, selects a candidate setting to be actually utilized, and applies the selected candidate setting to each equipment 211 of the building.

The constraint level is an index value that must always be satisfied in building operation. Therefore, it is possible to utilize a setting having a high constraint level, that is, a setting that meets the constraint.

The satisfaction level is an index value for demands of a large number of stakeholders. This enables operating each equipment 211 of the building under a good setting that less influences the stakeholders.

The equipment control device 100 uses a technique that can compare superiority/inferiority of candidate settings even if a large number of constraint levels or a large number of satisfaction levels have different value ranges. Then, an optimum setting can be acquired more efficiently, and operation under a good setting can be started quickly.

### Examples of Embodiment 1

### Example (1-1)

The selection unit 112 may select the applicable setting as follows.

First, the selection unit 112 displays a plurality of new setting candidates together with their individual satisfaction levels and constraint levels onto the display (output device 202).

Next, the user (for example, the building manager) designates conditions (for example, allowable ranges) of the satisfaction level and constraint level with using the input device 201.

Then, the selection unit 112 selects a candidate setting that satisfies the designated conditions from among the plurality of new candidate settings. The candidate setting to be selected is the applicable setting.

### Example (1-2)

In operations of the selection unit 112, an input/output device connected to an external device may be used instead of the output device 202 and input device 201 connected to the equipment control device 100. This is realized by the selection unit 112 communicating with the external device.

### Example (1-3)

The control unit 113 may apply a provisional setting to one or more units of equipment 211 before the optimization end condition is satisfied. The provisional setting is a candidate setting that is applied temporarily.

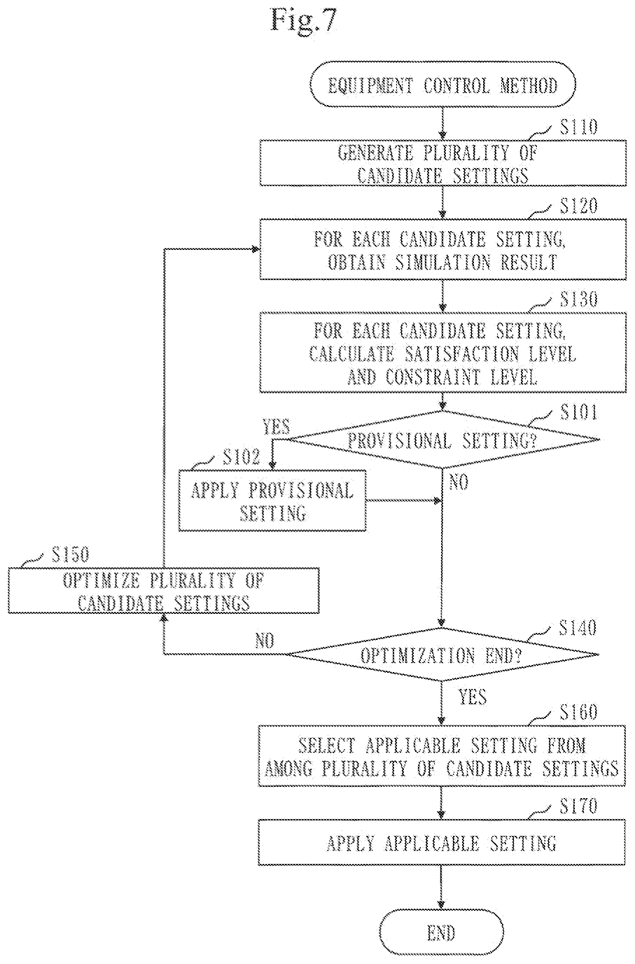

An equipment control method will be described with referring to FIG. 7. Step S101 and step S102 characterize the equipment control method.

After step S130, the processing proceeds to step S101.

In step S101, the control unit 113 judges whether a provisional setting condition is satisfied.

The provisional setting condition is determined in advance as a condition for applying the provisional setting. For example, the provisional setting condition is fixed about a number of execution times of optimization (step S150) or a time that has passed (since step S110). The number of execution times of optimization in the provisional setting condition is smaller than the number of execution times of optimization in the optimization end condition.

If the provisional setting condition is satisfied, the processing proceeds to step S102.

If the provisional setting condition is not satisfied, the processing proceeds to step S140.

In step S102, the selection unit 112 selects a provisional setting from among a plurality of present candidate settings. The selection may be formed according to an arbitrary method.

Then, the control unit 113 applies the provisional setting to one or more units of equipment 211.

After step S102, the processing proceeds to step S140.

According to this, the provisional setting can be temporarily applied without a need to wait for completion of optimization calculation (S120 to S150) which takes time. Therefore, it is possible to operate a building by applying a setting that is appropriate to a certain extent, without a need of human intervention. After that, when optimization calculation is completed, a finally obtained good setting is applied, so that the operation of the building can be performed.

### Embodiment 2

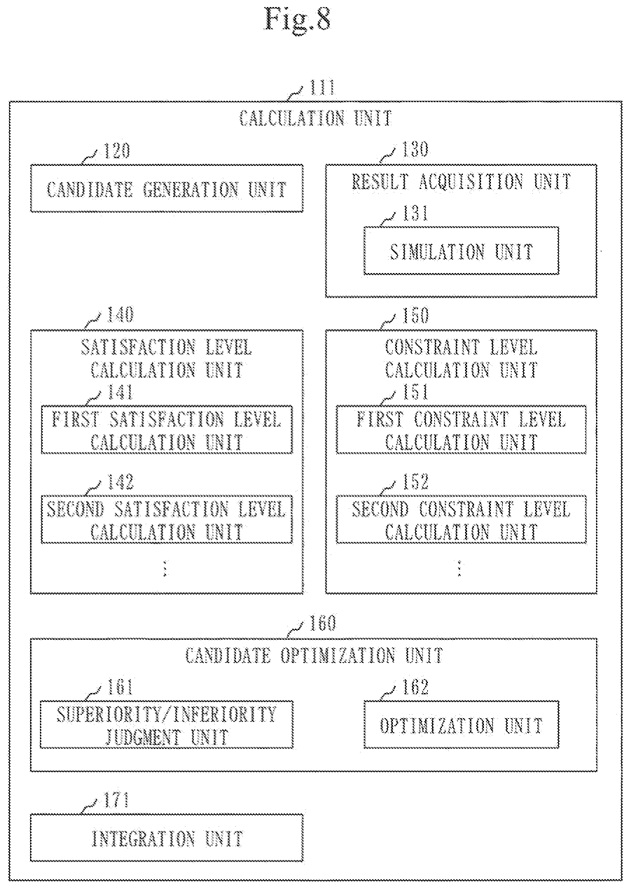

An embodiment of integrating two or more satisfaction levels about two or more particular indices into one satisfaction level will be described mainly regarding its differences from Embodiment 1 with referring to FIGS. 8 to 10.

### Outline of Embodiment 2

In Embodiment 1, when a plurality of satisfaction levels are calculated for each candidate setting, the candidate settings are ranked with using all of the plurality of satisfaction levels calculated for each candidate setting.

However, some indices of the satisfaction levels may have the same changing trend. In that case, when ranking the candidate settings, the satisfaction levels of those indices need not be considered separately.

In view of this, in Embodiment 2, the candidate settings are ranked after several satisfaction levels are integrated into one satisfaction level.

### Description of Configurations

A configuration of a building management system 200 is the same as the equivalent configuration in Embodiment 1.

A configuration of an equipment control device 100 is the same as the equivalent configuration in Embodiment 1.

It must be noted that a configuration of a calculation unit 111 is different from the equivalent configuration in Embodiment 1.

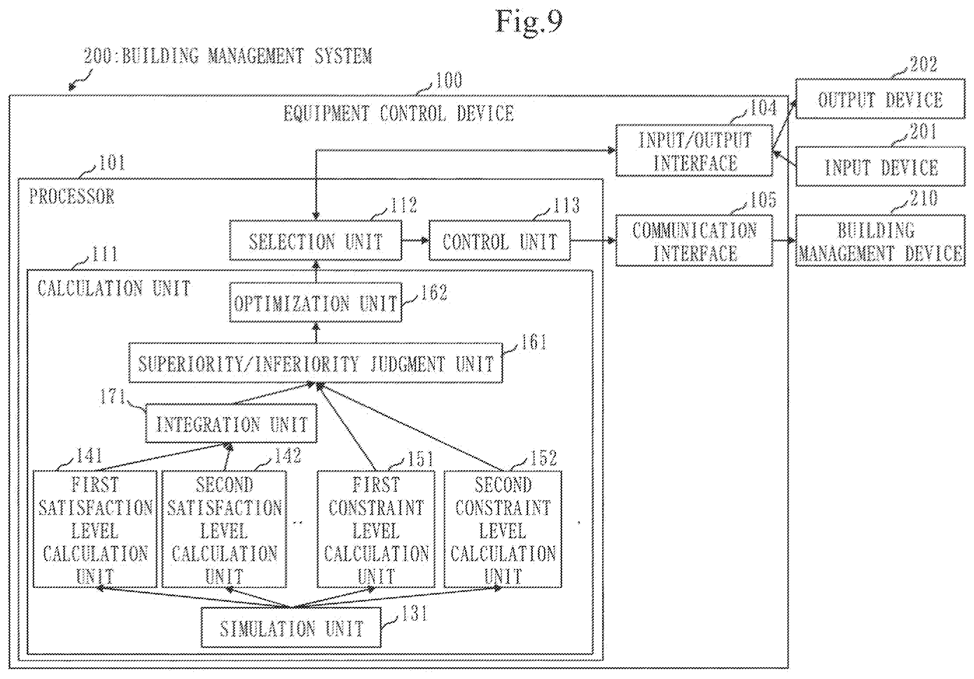

The configuration of the calculation unit 111 will be described with referring to FIGS. 8 and 9.

The calculation unit 111 is further provided with an integration unit 171. An equipment control program further causes the computer to function as the integration unit 171.

### Description of Operations

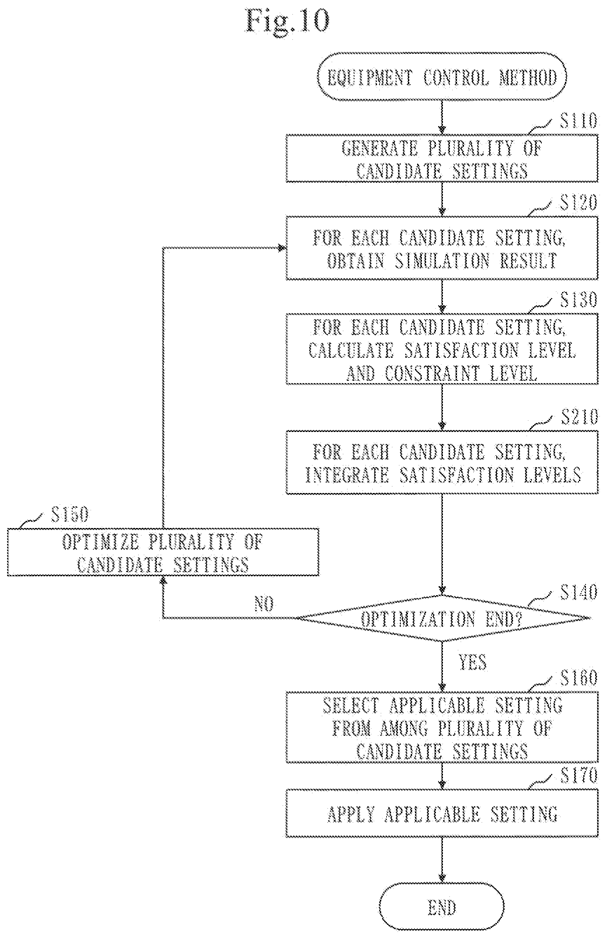

An equipment control method will be described with referring to FIG. 10. Step S210 characterizes the equipment control method.

Step S110 to step S170 have been described in Embodiment 1.

Step S210 is executed after step S130.

In step S130, a satisfaction level of a stakeholder is calculated. The satisfaction level of the stakeholder includes a plurality of satisfaction levels about a plurality of indices.

In step S210, the integration unit 171 integrates, for each candidate setting, two or more satisfaction levels about two or more particular indices out of the plurality of satisfaction levels included in the satisfaction level of the stakeholder, into one satisfaction level.

The two or more particular indices are determined in advance as two or more indices having the same change trend.

For example, among two or more satisfaction levels, the integration unit 171 leaves one satisfaction level and deletes the other satisfaction levels.

After step S210, the processing proceeds to step S140.

### Effect of Embodiment 2

The equipment control device 100 integrates several satisfaction levels into one satisfaction level, and then ranks the candidate settings. This reduces a number of satisfaction levels that must be compared. Usually, the larger the number of satisfaction levels that must be compared, the more difficult judgment of superiority/inferiority among the candidate settings. For example, a phenomenon can happen that even if the satisfaction level of the candidate setting A is higher than the satisfaction level of the candidate setting B in many indices and that the satisfaction level of the candidate setting B is higher than the satisfaction level of the candidate setting A in a few indices, it is hard to say that the candidate setting B is inferior to the candidate setting A. Such a phenomenon is likely to occur as the number of satisfaction levels increases. Accordingly, as the number of satisfaction levels to be compared decreases, superiority/inferiority judgment among the candidate settings becomes easier to perform. Further, a time required for calculation of ranking becomes shorter.

### Example of Embodiment 2

### Example (2-1)

The integration unit 171 may integrate two or more satisfaction levels as follows.

A priority order of two or more particular indices is determined in advance.

The integration unit 171 weights the satisfaction levels about the individual indices in accordance with the priority order, and calculates a weighting sum of the satisfaction levels. The weighting sum to be calculated is one satisfaction level obtained by integration.

A weight of each index may be calculated in advance on a basis of the priority order, or may be designated by the user with using an input device 201.

When two or more satisfaction levels are integrated, superiority/inferiority judgment among the candidate settings becomes easier to perform, and a time required for calculation of ranking becomes shorter.

### Embodiment 3

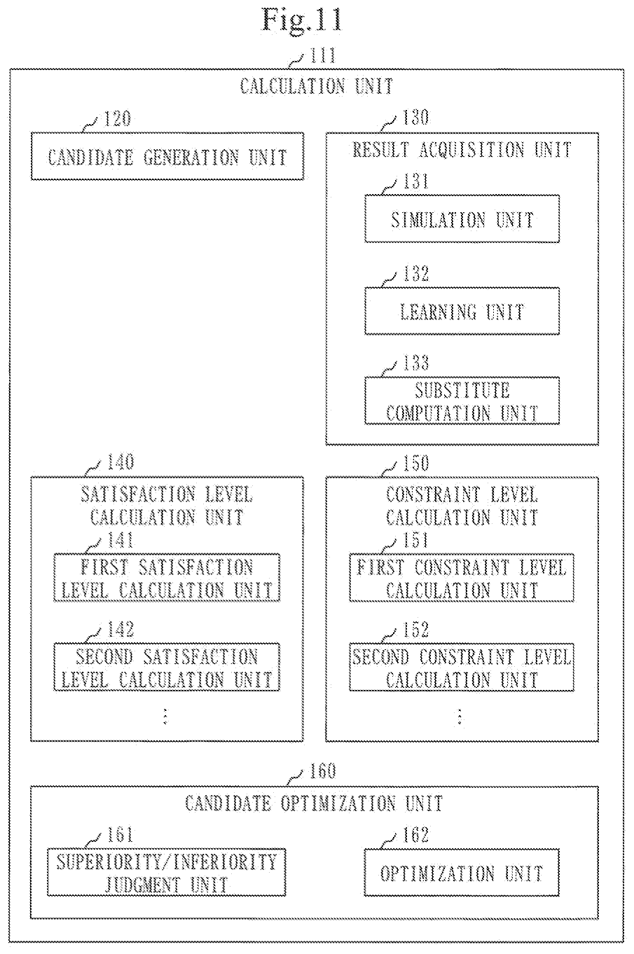

An embodiment of obtaining a simulation result by using a learned model will be described mainly regarding its differences from Embodiment 1 with referring to FIGS. 11 to 16.

### Outline of Embodiment 3

In Embodiment 1, an energy consumption of each equipment 211 and an indoor environment of each room during operation of a target building are calculated by simulation using the individual candidate settings.

However, when performing simulation with a high precision, an elaborate physical model is required, and a simulation is prolonged. If the building is large, there are many units of equipment 211 to serve as a modeling target, and the simulation is further prolonged. As a result, it may take time to acquire a candidate setting to be applied to the operation of the building.

In view of this, in Embodiment 3, a learned model is used. Thus, a calculation time required for obtaining a simulation result becomes shorter.

### Description of Configurations

A configuration of a building management system 200 is the same as the equivalent configuration in Embodiment 1.

A configuration of an equipment control device 100 is the same as the equivalent configuration in Embodiment 1.

It must be noted a configuration of a calculation unit 111 is different from the equivalent configuration in Embodiment 1.

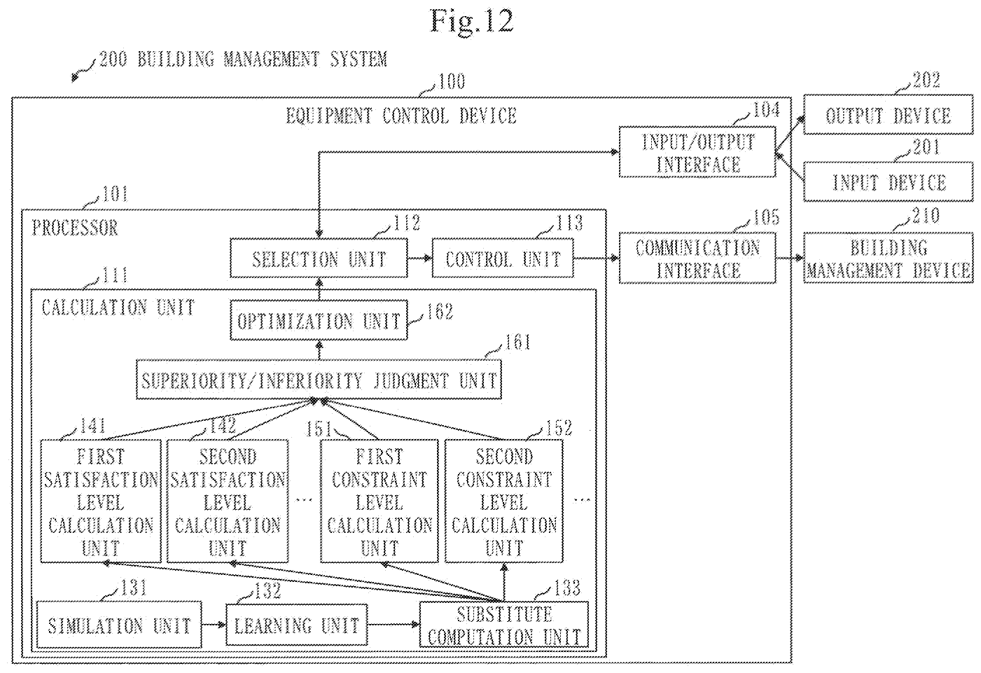

The configuration of the calculation unit 111 will be described with referring to FIGS. 11 and 12.

In the calculation unit 111, a result acquisition unit 130 is provided with a learning unit 132 and a substitute computation unit 133 in addition to a simulation unit 131.

### Description of Operations

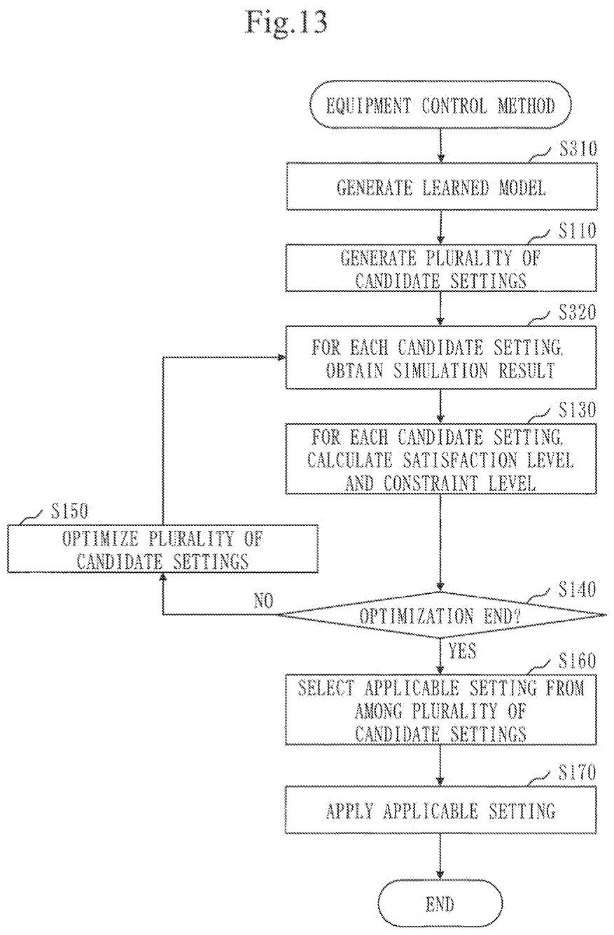

An equipment control method will be described with referring to FIG. 13. Step S310 and step S320 characterize the equipment control method.

Step S110 and step S130 to step S170 have been described in Embodiment 1.

Step S310 is executed before step S320. For example, step S310 is executed before step S110.

Step S320 corresponds to step S120 of Embodiment 1.

In step S310, the result acquisition unit 130 generates a learned model.

The learned model is a function of taking as input a setting for one or more units of equipment 211 and outputting a simulation result.

Specifically, the result acquisition unit 130 operates as follows.

First, the simulation unit 131 simulates the operation of the building on a basis of each of a plurality of virtual settings for one or more units of equipment 211. Thus, a simulation result is obtained for each virtual setting.

The virtual setting is a setting used for leaning. For example, the virtual setting is generated by a candidate generation unit 120.

The learning unit 132 learns, for each virtual setting, a set of the virtual setting and the simulation result (data set). Hence, a learned model is generated.

The type of the learned model is arbitrary.

Specifically, the type of the learned model is a neural network, a random forest, an SVR, or the like.

Note that SVR stands for Support Vector Regression.

In step S320, for each candidate setting, the result acquisition unit 130 obtains a simulation result of the candidate setting with using the learned model.

Specifically, the substitute computation unit 133 takes each candidate setting as input and computes the learned model. Hence, a simulation result of each candidate setting can be obtained.

### Effect of Embodiment 3

The equipment control device 100 can calculate an energy consumption and an indoor environment at a high speed by the learned model that substitutes for a simulation.

The equipment control device 100 causes the model to learn an input/output relationship of the simulation in advance. This enables high-speed calculation of the energy consumption and indoor environment. As a result, good candidate setting can be acquired at a high speed.

Further, even when a required satisfaction level is added or changed due to a change of the stakeholder such as a change of a tenant moving in the building, a good candidate setting can be acquired at a high speed and can be applied to building equipment control.

### Examples of Embodiment 3

### Example (3-1)

The result acquisition unit 130 may generate a learned model by using the candidate setting obtained in optimization (step S150) in addition to the virtual setting. That is, the simulation unit 131 performs simulation for each new candidate setting obtained by optimization, and obtains a simulation result. Then, the learning unit 132 learns a set of new candidate setting and simulation result, and updates the learned model.

This improves an accuracy of the simulation result of energy consumption, indoor environment, and the like, and makes it possible to acquire a better candidate setting.

### Example (3-2)

The result acquisition unit 130 may generate a learned model by using, for learning, data of a building having a similar feature as that of the building whose applicable candidate is to be determined.

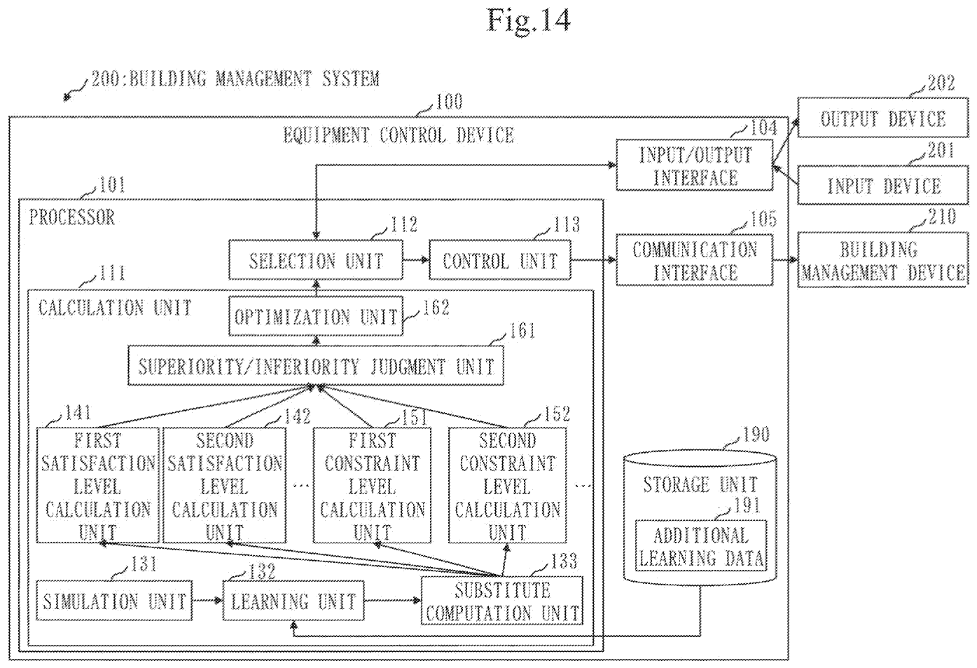

Referring to FIG. 14, additional learning data 191 is stored in a storage unit 190.

The additional learning data 191 is learning data of another building, and includes one or more sets of a setting of another building and a simulation result based on the setting of another building.

The learning unit 132 learns the additional learning data 191 and generates a learned model. This reduces the number of (or eliminates) virtual settings necessary for learning, so that a time necessary for simulation of the virtual settings is shortened (or becomes unnecessary). As a result, it is possible to complete prior learning within a shorter period of time and to generate a learned model.

### Example (3-3)

What is ultimately necessary for judging superiority/inferiority among candidate settings is not a simulation result but a satisfaction level and a constraint level. Therefore, the equipment control device 100 may learn the satisfaction level and the constraint level.

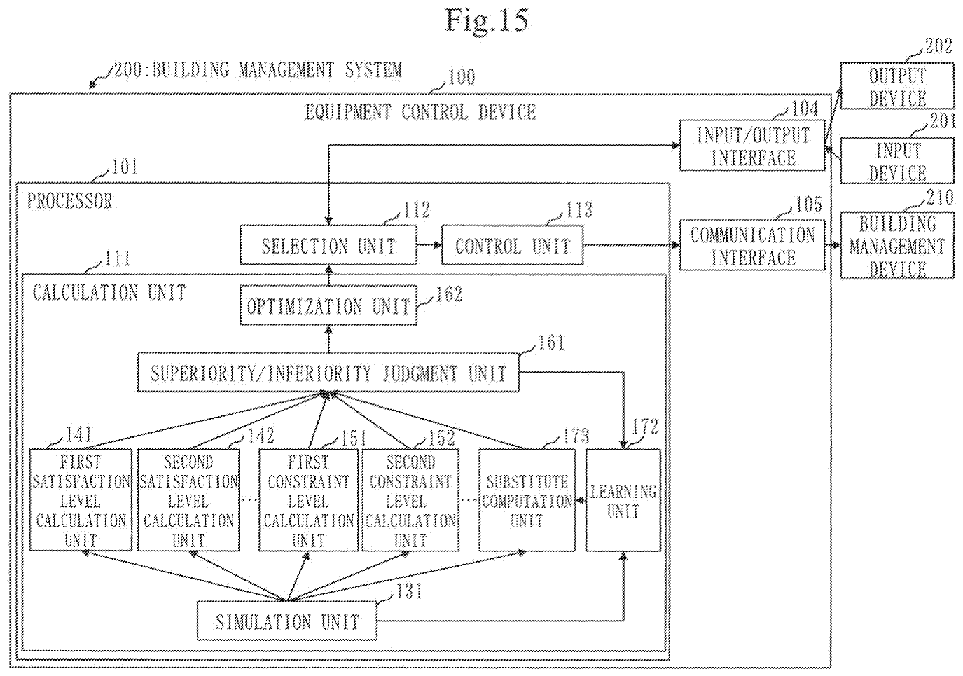

In FIG. 15, the calculation unit 111 is provided with a learning unit 172 and a substitute computation unit 173.

The learning unit 172 generates a learned model by learning, for each virtual setting, a set of the virtual setting, the satisfaction level, and the constraint level (data set).

The substitute computation unit 173 calculates the satisfaction level and the constraint level for each candidate setting with using the learned model.

This enables acquisition of a good candidate setting by performing optimization calculation (S120 to S150) faster.

The equipment control device 100 may learn superiority/inferiority judgment (ranking) of settings likewise.

### Example (3-4)

Example (3-3) may be applied to Example (3-4).

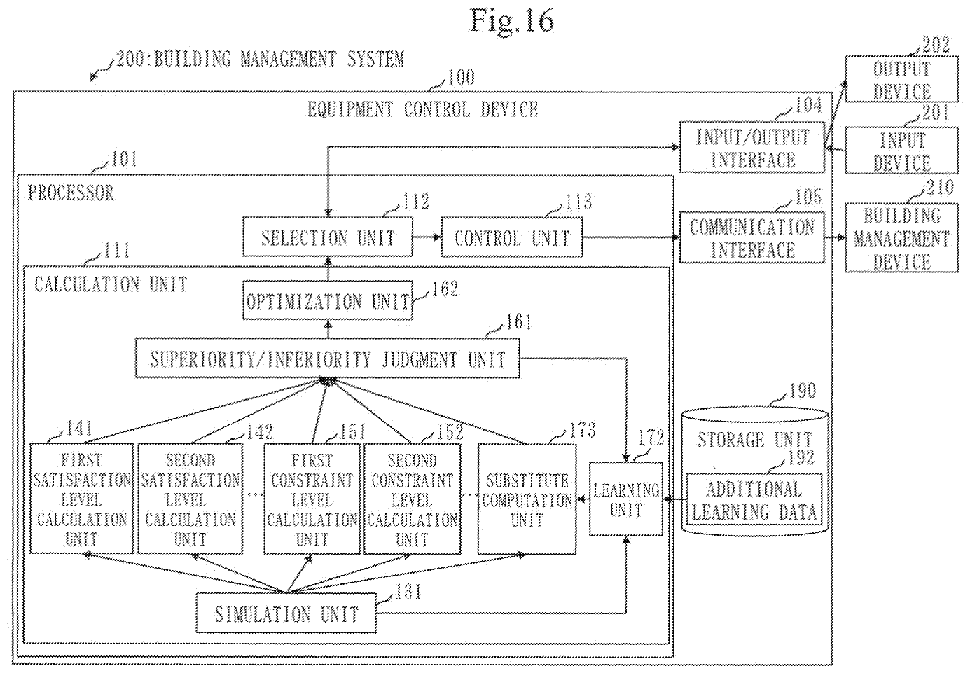

Referring to FIG. 16, additional learning data 192 is stored in the storage unit 190. The additional learning data 192 is learning data of another building, and includes one or more sets of a setting of another building, satisfaction level based on the setting of another building and constraint level based on the setting of another building.

The learning unit 132 learns the additional learning data 192 and generates a learned model.

This enables completion of prior learning and generation of a learned model within a shorter period of time, just as in Example (3-3).

The equipment control device 100 may likewise learn additional learning data about superiority/inferiority judgment of settings (ranking).

### Embodiment 4

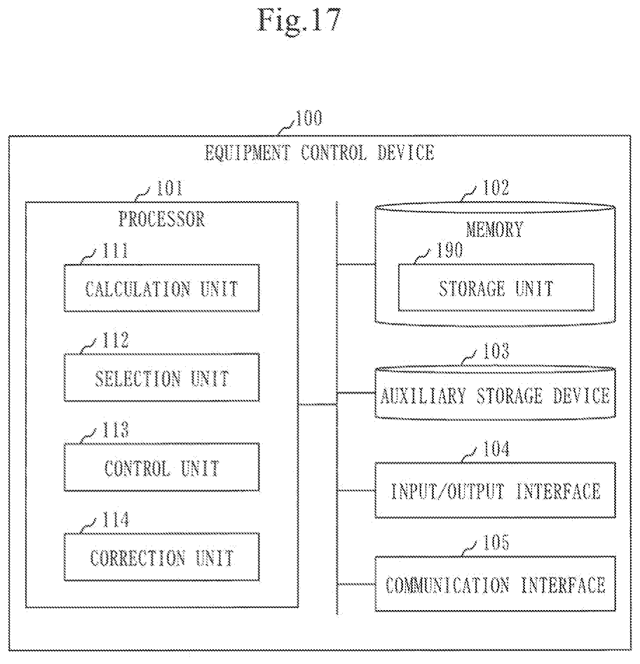

An embodiment of correcting a simulation parameter will be described mainly regarding its differences from Embodiment 1 with referring to FIGS. 17 to 20.

### Outline of Embodiment 4

In Embodiment 1, optimization calculation is performed assuming that simulation can be performed with a high precision.

However, if the simulation model is inaccurate, or if the characteristics of the equipment 211 change over time, it may become difficult to perform simulation with a high precision.

In view of this, in Embodiment 4, information such as the characteristics of the actual equipment 211 and changes in indoor environment is collected, and the simulation parameter is corrected appropriately.

### Description of Configurations

A configuration of a building management system 200 is the same as the equivalent configuration in Embodiment 1.

It must be noted that a configuration of an equipment control device 100 is different from the equivalent configuration in Embodiment 1.

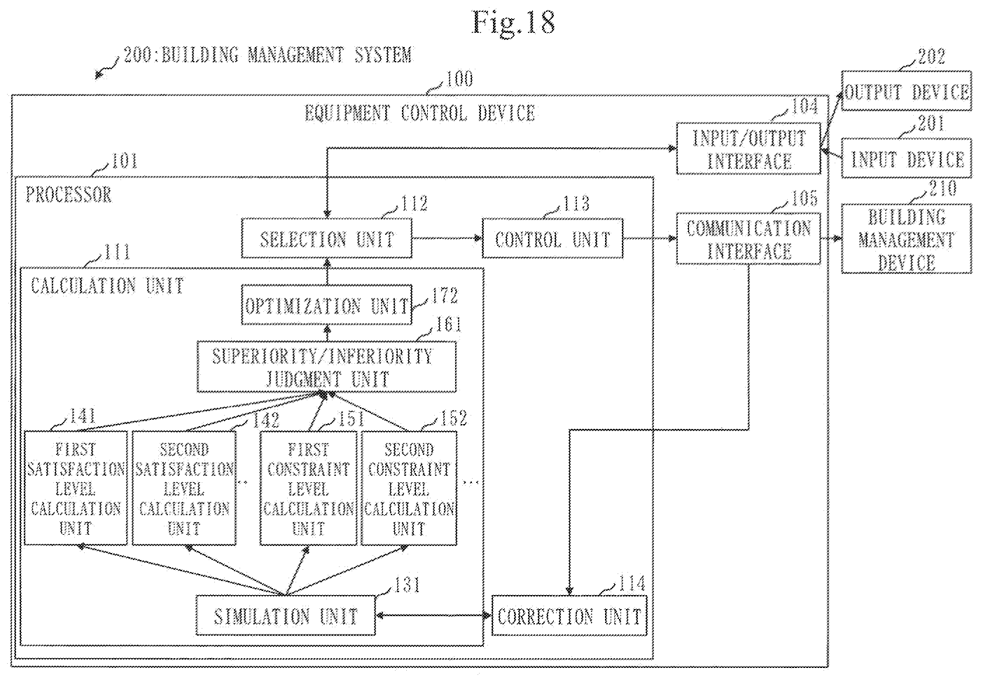

The configuration of the equipment control device 100 will be described with referring to FIGS. 17 and 18.

The equipment control device 100 is further provided with an element called correction unit 114. An equipment control program further causes the computer to function as the correction unit 114.

### Description of Operations

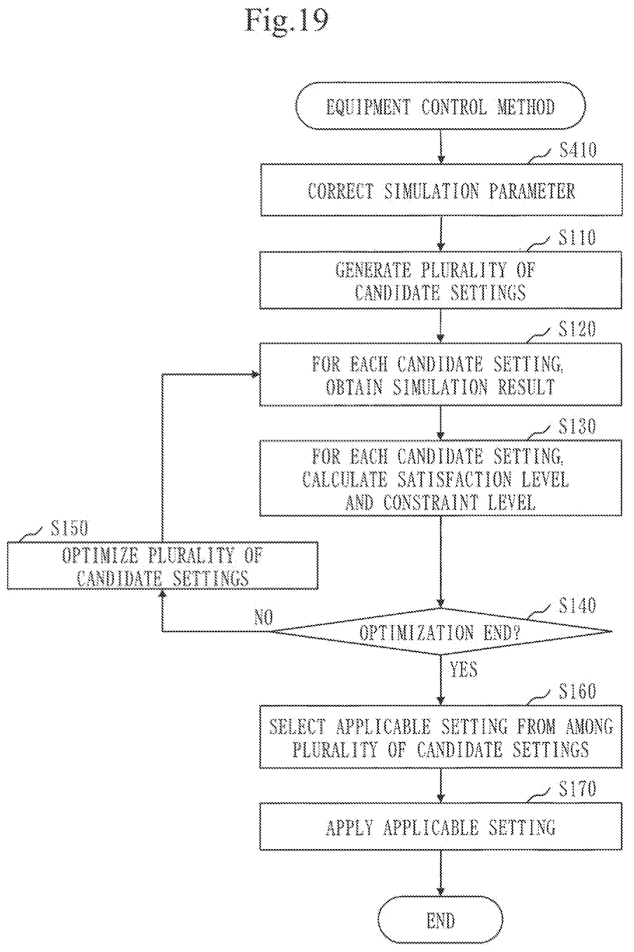

An equipment control method will be described with referring to FIG. 19. Step S410 characterizes the equipment control method.

Step S410 is executed before step S120. For example, step S410 is executed before step S110.

In step S410, the correction unit 114 acquires a past setting applied to one or more units of equipment 211, and an operation result of the building obtained when the past setting is applied.

Specifically, the correction unit 114 communicates with a building management device 210 to acquire a present setting, and an operation result based on the present setting. The present setting is a setting that was set in the past and has been applied currently, and is an example of the past setting.

Further, the correction unit 114 compares a simulation result under the past setting with the operation result.

The simulation result under the past setting is obtained when a simulation unit 131 executes a simulation based on the past setting.

Then, the correction unit 114 corrects a simulation parameter on a basis of a comparison result.

The simulation parameter is a parameter used in the simulation performed by the simulation unit 131.

Specifically, the correction unit 114 corrects the simulation parameter if an error in simulation result against the operation result exceeds a threshold value. At this time, the correction unit 114 changes a value of the parameter in accordance with a size of the error so that a simulation result close to the operation result can be obtained.

### Effect of Embodiment 4

The equipment control device 100 corrects the simulation parameter before simulation. Thus, simulation will not be performed with a low precision. Hence, it is possible to acquire a higher-precision, better candidate setting.

### Examples of Embodiment 4

### Example (4-1)

The correction unit 114 may perform correction before simulation (step S120) in optimization calculation (S120 to S150). For example, the correction unit 114 may perform correction before optimization (step S150).

The correction unit 114 may perform correction periodically.

### Example (4-2)

In the case of Example (4-1), the simulation parameter is corrected during optimization calculation (S120 to S150). Accordingly, the satisfaction level and constraint level based on the same candidate setting change during the optimization calculation, and there is a possibility that effective optimization results cannot be obtained.

In view of this, when correction has been made, the equipment control device 100 may suspend the optimization calculation for the time being.

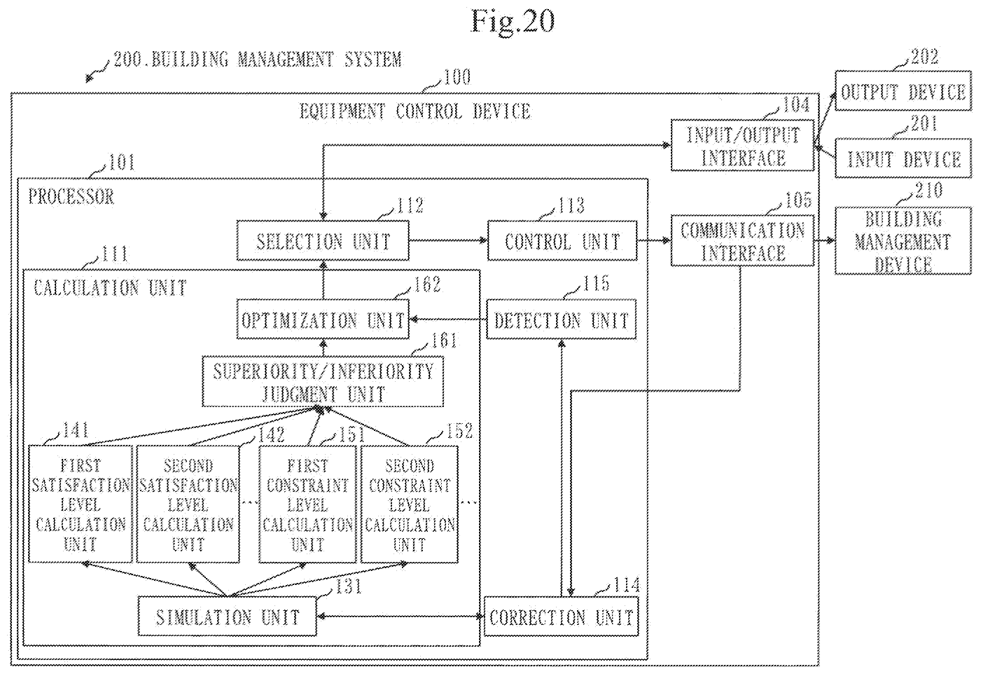

Referring to FIG. 20, the calculation unit 111 is provided with a detection unit 115.

The detection unit 115 detects correction of a simulation parameter.

When correction of the simulation parameter is detected, the satisfaction level calculation unit 140, the constraint level calculation unit 150, and the candidate optimization unit 160 stop a running process, and then restart the stopped process. That is, the satisfaction level and the constraint level are recalculated, and optimization is performed on a basis of the recalculated satisfaction level and constraint level. The equipment control device 100 may execute the optimization calculation again from the beginning.

Hence, even when the simulation parameter has been corrected during the optimization calculation, the candidate setting can be optimized with using the higher-precision corrected satisfaction level and constraint level instead of the pre-correction satisfaction level and constraint level. This makes it possible to acquire a good candidate setting.

### Embodiment 5

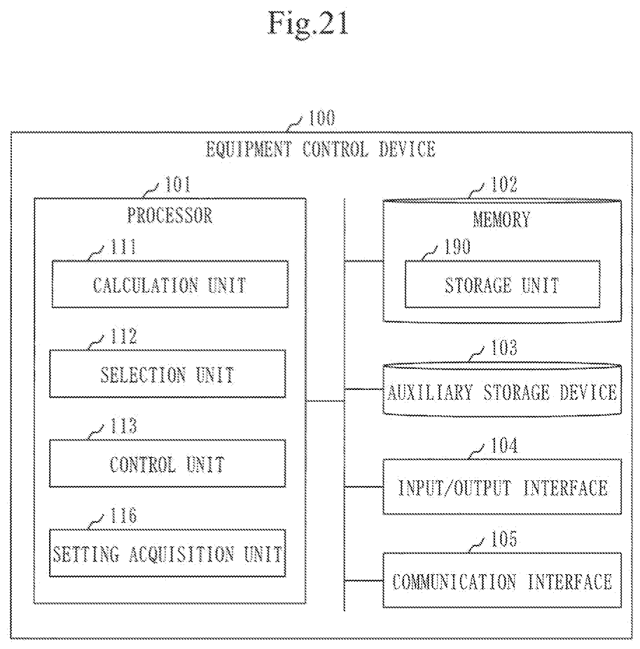

An embodiment of selecting an applicable setting on a basis of the present setting of equipment 211 will be described mainly regarding its differences from Embodiment 1 with referring to FIGS. 21 to 23.

### Outline of Embodiment 5

In Embodiment 1, the applicable setting is selected from among the plurality of candidate settings.

However, if an applicable setting is selected without considering a present status of the building, the applicable setting may deviate from the present setting, causing significant changes in the in-door environment to make people in the building feel uncomfortable or burdened.

In view of this, in Embodiment 5, a candidate setting close to the present setting is selected as an applicable setting from among a plurality of candidate settings.

### Description of Configurations

A configuration of a building management system 200 is the same as the equivalent configuration in Embodiment 1.

It must be noted that a configuration of an equipment control device 100 is different from the equivalent configuration in Embodiment 1.

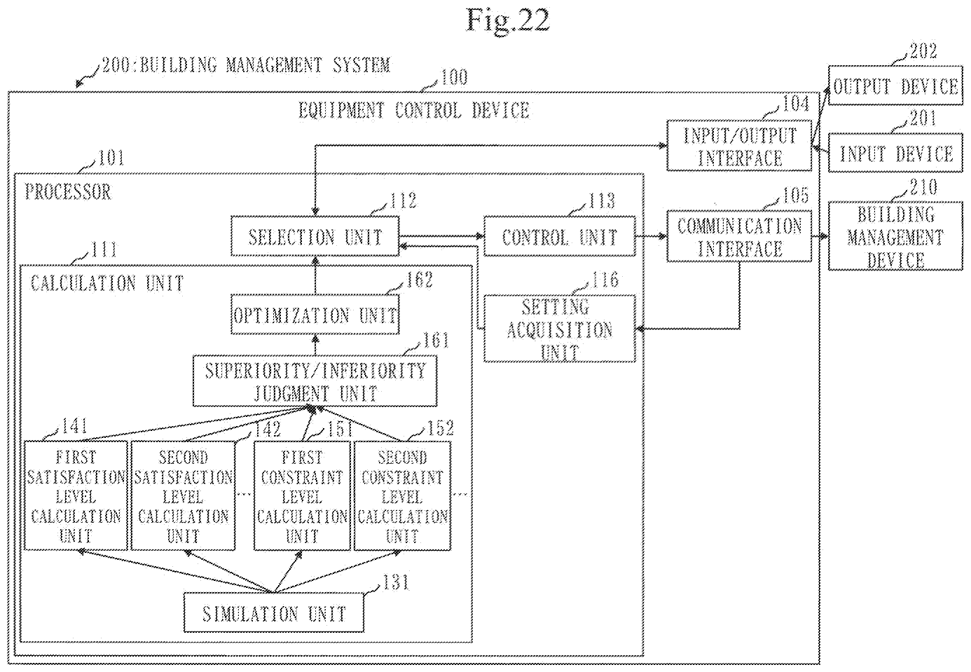

The configuration of the equipment control device 100 will be described with referring to FIGS. 21 and 22.

The equipment control device 100 is provided with an element called setting acquisition unit 116. An equipment control program further causes the computer to function as the setting acquisition unit 116.

### Description of Operations

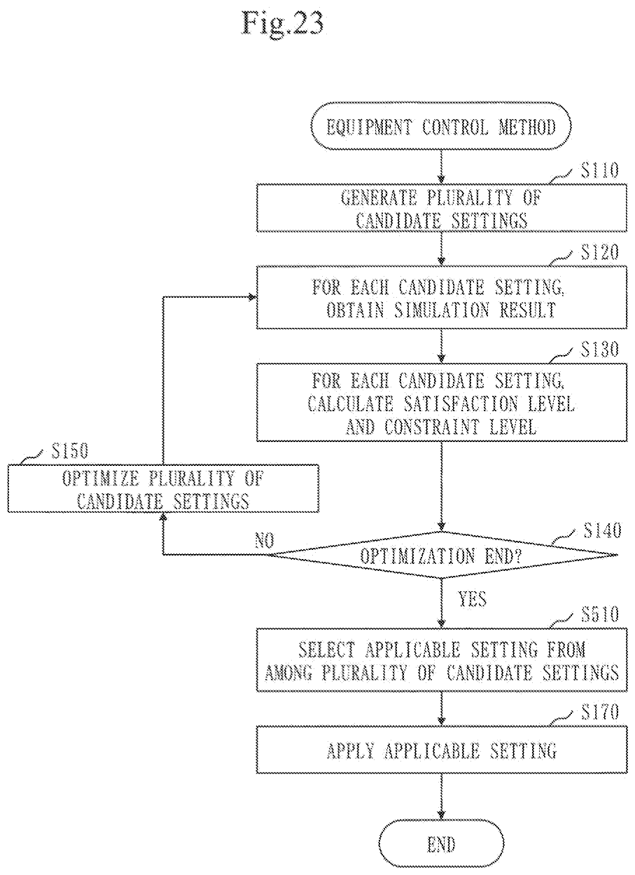

An equipment control method will be described with referring to FIG. 23. Step S510 characterizes the equipment control method.

Step S110 to step S150 and step S170 have been described in Embodiment 1.

Step S510 corresponds to step S160 of Embodiment 1.

In step S510, the setting acquisition unit 116 acquires a setting (preset setting) being applied to one or more units of equipment 211.

Specifically, the setting acquisition unit 116 communicates with a building management device 210 to acquire the present setting.

Then, a selection unit 112 selects an applicable setting on a basis of the present setting.

For example, the applicable setting is selected as follows.

First, the selection unit 112 displays, for each candidate setting, a candidate setting and its satisfaction level and constraint level to a display (output device 202), and displays the present setting and its satisfaction level and constraint level to the display. The satisfaction level and constraint level of the present setting are calculated in the same manner as the satisfaction level and constraint level of the candidate setting.

Next, the user (for example, the building manager) refers to the displayed information, selects a desirable candidate setting from among a plurality of candidate settings, and designates the desirable candidate setting with using an input device 201. At this time, preferably, the user selects a candidate setting not deviating from the present setting.

Then, the selection unit 112 selects the designated candidate setting from among the plurality of candidate settings. The candidate setting to be selected is the applicable setting.

### Effect of Embodiment 5

The equipment control device 100 acquires a setting that has been applied most recently and selects a candidate setting that is close to the most recent setting from among a plurality of candidate settings. Thus, a setting deviating from the setting that has been applied until just recently will not be applied anew. This reduces changes in an in-room environment, making it possible to reduce discomfort and burden to the building user due to environmental change.

### Examples of Embodiment 5

### Example (5-1)

Instead of presenting all of the plurality of candidate settings to the user, the selection unit 112 may extract a candidate setting close to the present setting from among a plurality of candidate settings, and may present the extracted candidate setting to the user. For example, the candidate setting close to the present setting is a candidate setting whose difference from the present setting is smaller than a threshold value.

Thus, the user will not select a candidate setting deviating from the present setting.

### Example (5-2)

The optimization unit 162 may perform optimization so that a new candidate setting close to the present setting can be obtained. That is, the optimization unit 162 may generate a new candidate setting close to the present setting by optimizing a plurality of candidate settings.

Accordingly, only a candidate setting close to the present setting is acquired. Thus, a candidate setting deviating from the present setting will not be selected.

### Embodiment 6

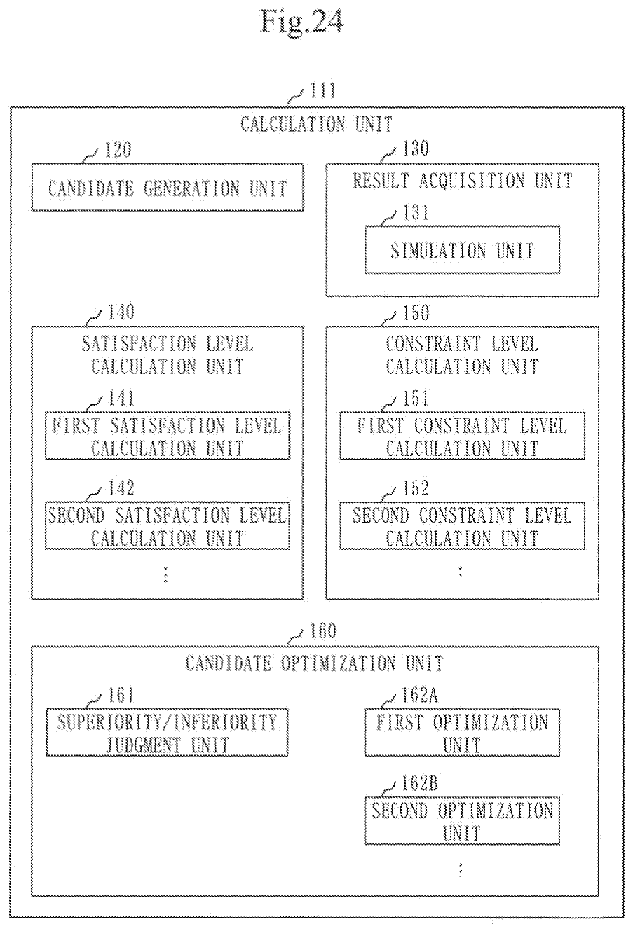

An embodiment of utilizing a plurality of optimization algorithms will be described mainly regarding its differences from Embodiment 1 with referring to FIGS. 24 to 27.

### Outline of Embodiment 6

In Embodiment 1, optimization of the candidate setting is performed with using one technique.

However, as has been described in Embodiment 1, there are a plurality of optimization techniques. Each technique has a different feature. Accordingly, a feature and trend of a candidate setting to be acquired may differ according to the technique employed. Also, depending on the technique to be used, a candidate setting indicating a good satisfaction level may not be acquired.

If one technique is to be used, it is necessary to verify which technique enables acquisition of a candidate setting having a good satisfaction level and constraint level with respect to the feature of the building.

In view of this, in Embodiment 6, optimization of the candidate setting is performed by a plurality of optimization techniques in a parallel manner. Then, a candidate setting acquired by a technique that meets the constraint and provides a better satisfaction level is employed.

### Description of Configurations

A configuration of a building management system 200 is the same as the equivalent configuration in Embodiment 1.

A configuration of an equipment control device 100 is the same as the equivalent configuration in Embodiment 1.

It must be noted that a configuration of a calculation unit 111 is different from the equivalent configuration in Embodiment 1.

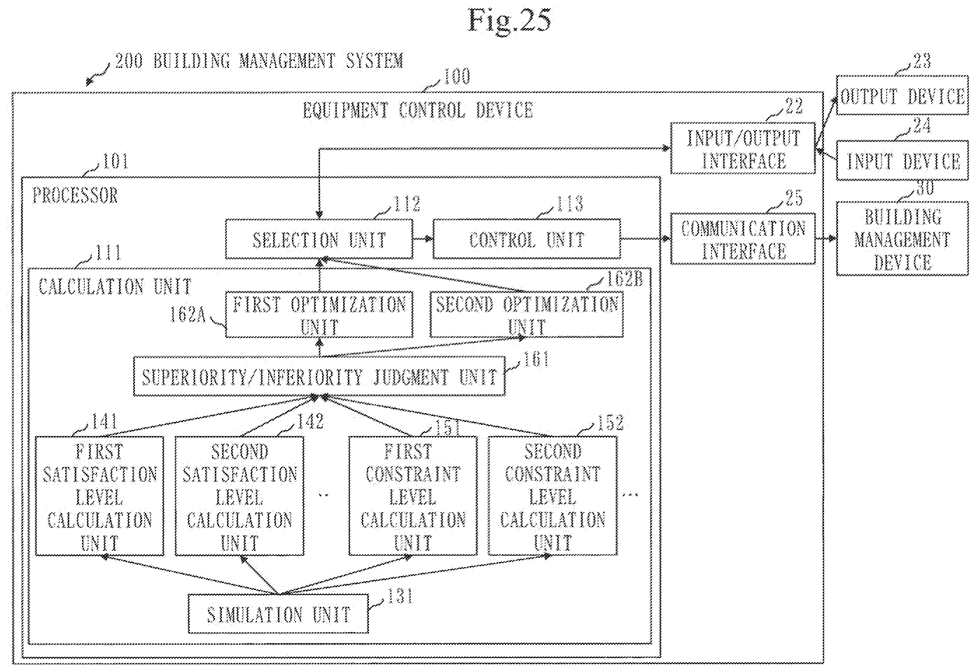

The configuration of the calculation unit 111 will be described with referring to FIGS. 24 and 25.

In the calculation unit 111, a candidate optimization unit 160 is provided with a plurality of optimization units 162. For example, the candidate optimization unit 160 is provided with a first optimization unit 162A and a second optimization unit 162B.

### Description of Operations

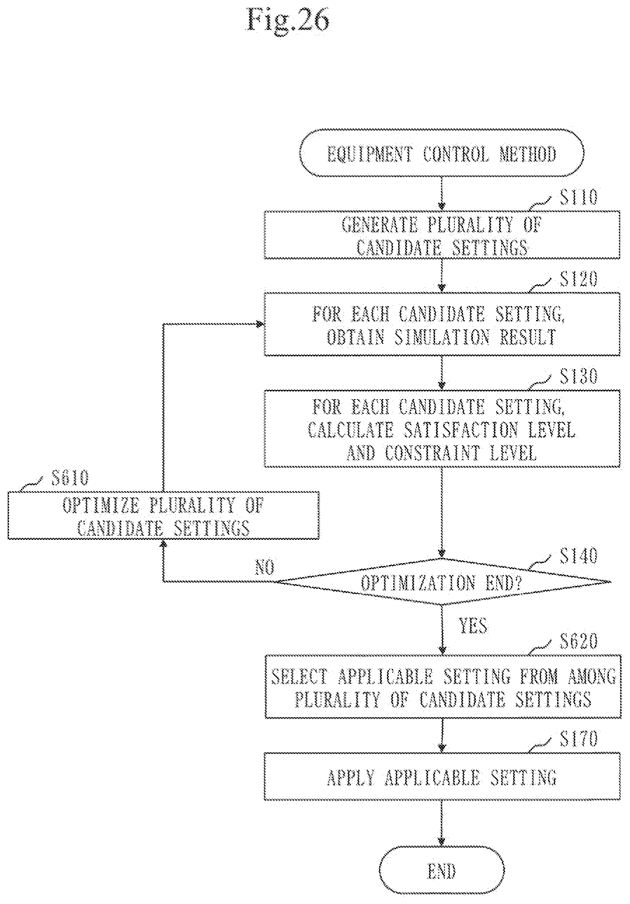

An equipment control method will be described with referring to FIG. 26. Step S610 and step S620 characterize the equipment control method.

Step S110 to step S140 and step S170 have been described in Embodiment 1.

Step S610 corresponds to step S150 of Embodiment 1.

Step S620 corresponds to step S160 of Embodiment 1.

In step S610, the candidate optimization unit 160 optimizes a plurality of candidate settings with using each of a plurality of optimization algorithms, thereby generating a plurality of candidate setting groups.

Each candidate setting group is generated for the individual optimization algorithm and is formed of a plurality of new candidate settings obtained by optimization.

When two optimization algorithms are used, the candidate optimization unit 160 operates as follows.

First, a superiority/inferiority judgment unit 161 ranks a plurality of candidate settings.

Then, the optimization unit 162 optimizes the plurality of setting candidates with the two optimization algorithms, thereby generating two candidate setting groups. For example, the first optimization unit 162A performs optimization by SBX and PM which are employed in MOGA. The second optimization unit 162B performs optimization by a technique (a technique that simulates flying) like the one used in Multi-Objective Particle Swarm Optimization (MOPSO).

In step S620, the selection unit 112 selects one out of the plurality of candidate setting groups.

Specifically, the selection unit 112 selects candidate setting groups having a better satisfaction level and a better constraint level.

Then, the selection unit 112 selects an applicable setting from among a plurality of new candidate settings that constitute the plurality of selected candidate setting groups.

### Effect of Embodiment 6

The equipment control device 100 performs optimization of the candidate setting by a plurality of optimization techniques in a parallel manner, and employs a candidate setting acquired by a technique that meets the constraint and provides a better satisfaction level. Then, even if a very good candidate setting cannot be acquired by some optimization technique, it is possible to employ a good candidate setting acquired by another optimization technique. As a result, an event that a good candidate setting cannot be acquired due to use of an inappropriate technique can be prevented.

Also, a good candidate setting can be acquired without verifying which technique enables acquisition of a candidate setting having a good satisfaction level and constraint level with respect to the feature of the building.

### Example of Embodiment 6

### Example (6-1)

A technique that enables appropriate superiority/inferiority judgment differs depending on the index of the satisfaction level or constraint level. Depending on technique to be used, appropriate superiority/inferiority judgment is not performed, and accordingly a candidate setting having a good satisfaction level may not be acquired.

In view of this, the candidate optimization unit 160 may rank the plurality of candidate settings by using each of the plurality of superiority/inferiority judgment algorithms.

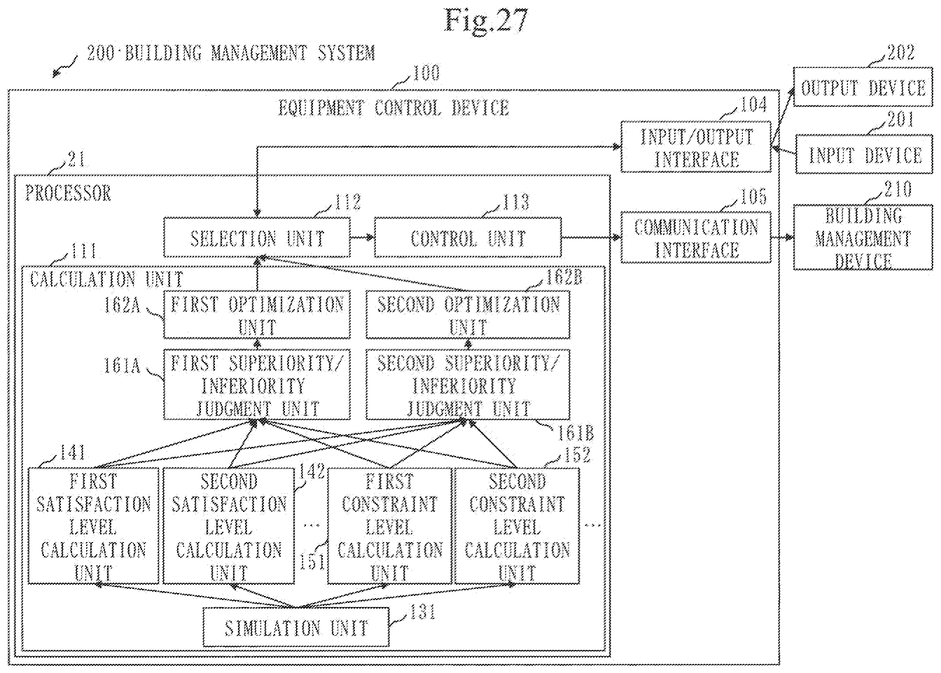

Referring to FIG. 27, the calculation unit 111 is provided with a plurality of superiority/inferiority judgment units (161A, 161B).

The first superiority/inferiority judgment unit 161A performs ranking with using a first superiority/inferiority judgment algorithms. The first optimization unit 162A performs optimization on a basis of a result of ranking performed by the first superiority/inferiority judgment unit 161A.

The second superiority/inferiority judgment unit 161B performs ranking with using a second superiority/inferiority judgment algorithms. The second optimization unit 162B performs optimization on a basis of a result of ranking performed by the second superiority/inferiority judgment unit 161B.

Note that each of the first optimization unit 162A and the second optimization unit 162B may perform optimization on a basis of the result of ranking performed by the first superiority/inferiority judgment unit 161A and the result of ranking performed by the second superiority/inferiority judgment unit 161B.

A number of superiority/inferiority judgment units 161 (that is, a number of superiority/inferiority judgment algorithms to be used) may be 3 or more, and a number of optimization units 162 (that is, a number of optimization algorithms to be used) may be 3 or more. The number of superiority/inferiority judgment units 161 and the number of optimization units 162 may be different from each other.

### Supplement to Embodiments

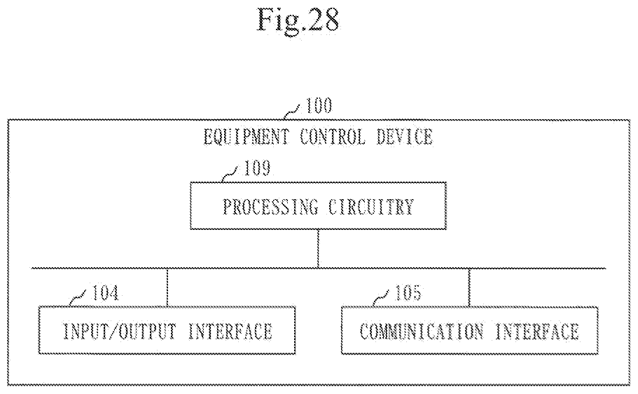

A hardware configuration of the equipment control device 100 will be described with referring to FIG. 28.

The equipment control device 100 is provided with processing circuitry 109.

The processing circuitry 109 is hardware that implements the calculation unit 111, the selection unit 112, the control unit 113, the correction unit 114, the detection unit 115, and the setting acquisition unit 116.

The processing circuitry 109 may be dedicated hardware, or may be a processor 101 that runs a program stored in a memory 102.

If the processing circuitry 109 is dedicated hardware, the processing circuitry 109 is one or a combination of, for example, a single circuit, a composite circuit, a programmed processor, a parallel-programmed processor, an ASIC, and an FPGA.

Note that ASIC stands for Application Specific Integrated Circuit.

Note that FPGA stands for Field Programmable Gate Array.

The equipment control device 100 may be provided with a plurality of units of processing circuitry that substitute for the processing circuitry 109.

In the processing circuitry 109, some of the functions may be implemented by dedicated hardware, and the remaining functions may be implemented by software or firmware.

In this manner, the functions of the equipment control device 100 can be implemented by one or a combination of hardware, software, and a firmware.

Each embodiment is an exemplification of a preferred mode, and is not intended to limit a technical scope of the present disclosure. Each embodiment may be practiced partly, or may be practiced in combination with another embodiment. Each example may be practiced in combination with another example. Procedures described with using flowcharts or the like may be changed appropriately.

A term “unit” being an element of the equipment control device 100 may be replaced by “process”, “stage”, “circuit” or “circuitry”.

### REFERENCE SIGNS LIST

100: equipment control device; 101: processor; 102: memory; 103: auxiliary storage device; 104: input/output interface; 105: communication interface; 109: processing circuitry; 111: calculation unit; 112: selection unit; 113: control unit; 114: correction unit; 115: detection unit; 116: setting acquisition unit; 120: candidate generation unit; 130: result acquisition unit; 131: simulation unit; 132: learning unit; 133: substitute computation unit; 140: satisfaction level calculation unit; 141: first satisfaction level calculation unit; 142: second satisfaction level calculation unit; 150: constraint level calculation unit; 151: first constraint level calculation unit; 152: second constraint level calculation unit; 160: candidate optimization unit; 161: superiority/inferiority judgment unit; 161A: first superiority/inferiority judgment unit; 161B: second superiority/inferiority judgment unit; 162: optimization unit; 162A: first optimization unit; 162B: second optimization unit; 171: integration unit; 172: learning unit; 173: substitute computation unit; 190: storage unit; 191: additional learning data; 192: additional learning data; 200: building management system; 201: input device; 202: output device; 210: building management device; 211: equipment.

1. An equipment control device comprising
processing circuitry
to obtain, for each candidate setting, a simulation result on a basis of a plurality of candidate settings which are a plurality of candidates for a setting to control one or more units of equipment installed in a building, the simulation result corresponding to a result of an operation of the building of a case where the candidate setting is applied to the one or more units of equipment,
to calculate, for each candidate setting, a satisfaction level of a stakeholder of the building on a basis of the simulation result,
to calculate, for each candidate setting, a constraint level on a basis of the simulation result, the constraint level expressing a degree of how much an operation constraint of the building is satisfied,
to judge superiority/inferiority of the plurality of candidate settings on a basis of the satisfaction level of each candidate setting and the constraint level of each candidate setting, and to optimize the plurality of candidate settings on a basis of a judgment result, thereby generating a plurality of new candidate settings,
to select a candidate setting to be applied to the one or more units of equipment as an applicable setting from among the plurality of new candidate settings, and
to apply the applicable setting to the one or more units of equipment.

2. The equipment control device according to claim 1, wherein the processing circuitry
calculates, for each candidate setting, a plurality of satisfaction levels about a plurality of indices, as the satisfaction level of the stakeholder, and
integrates, for each candidate setting, two or more satisfaction levels about two or more particular indices out of the plurality of satisfaction levels included in the satisfaction level of the stakeholder, into one satisfaction level.

3. The equipment control device according to claim 1, wherein the processing circuitry
simulates the operation of the building on a basis of each of a plurality of virtual settings for the one or more units of equipment, thereby obtaining a simulation result for each virtual setting,
learns, for each virtual setting, a set of the virtual setting and the simulation result, thereby generating a learned model, and
obtains, for each candidate setting, the simulation result of the candidate setting with using the learned model.

4. The equipment control device according to claim 1, wherein the processing circuitry
acquires a past setting applied to the one or more units of equipment, and an operation result of the building obtained when the past setting is applied, compares a simulation result under the past setting with the operation result, and corrects a simulation parameter on a basis of a comparison result.

5. The equipment control device according to claim 1, wherein the processing circuitry
acquires a preset setting being applied to the one or more units of equipment, and
selects the applicable setting on a basis of the present setting.

6. The equipment control device according to claim 1, wherein the processing circuitry
optimizes the plurality of candidate settings with using each of a plurality of optimization algorithms, thereby generating a plurality of candidate setting groups each formed of a plurality of new candidate settings, and
selects one out of the plurality of candidate setting groups, and selects the applicable setting from among the plurality of new candidate settings that constitute a plurality of selected candidate setting groups.

7. An equipment control method comprising:
obtaining, for each candidate setting, a simulation result on a basis of a plurality of candidate settings which are a plurality of candidates for a setting to control one or more units of equipment installed in a building, the simulation result corresponding to a result of an operation of the building of a case where the candidate setting is applied to the one or more units of equipment;
calculating, for each candidate setting, a satisfaction level of a stakeholder of the building on a basis of the simulation result;
calculating, for each candidate setting, a constraint level on a basis of the simulation result, the constraint level expressing a degree of how much an operation constraint of the building is satisfied;
judging superiority/inferiority of the plurality of candidate settings on a basis of the satisfaction level of each candidate setting and the constraint level of each candidate setting, and optimizing the plurality of candidate settings on a basis of a judgment result, thereby generating a plurality of new candidate settings;
selecting a candidate setting to be applied to the one or more units of equipment as an applicable setting from among the plurality of new candidate settings; and
applying the applicable setting to the one or more units of equipment.

8. A non-transitory computer readable medium recorded with an equipment control program which causes a computer to execute:
a result acquisition process of obtaining, for each candidate setting, a simulation result on a basis of a plurality of candidate settings which are a plurality of candidates for a setting to control one or more units of equipment installed in a building, the simulation result corresponding to a result of an operation of the building of a case where the candidate setting is applied to the one or more units of equipment;
a satisfaction level calculation process of calculating, for each candidate setting, a satisfaction level of a stakeholder of the building on a basis of the simulation result;
a constraint level calculation process of calculating, for each candidate setting, a constraint level on a basis of the simulation result, the constraint level expressing a degree of how much an operation constraint of the building is satisfied;
a candidate optimization process of judging superiority/inferiority of the plurality of candidate settings on a basis of the satisfaction level of each candidate setting and the constraint level of each candidate setting, and optimizing the plurality of candidate settings on a basis of a judgment result, thereby generating a plurality of new candidate settings;
a selection process of selecting a candidate setting to be applied to the one or more units of equipment as an applicable setting from among the plurality of new candidate settings; and
a control process of applying the applicable setting to the one or more units of equipment.
